(19) United States
(12) Patent Application Publication
(10) Pub. No.: US 2020/0205215 A1
(43) Pub. Date: Jun. 25, 2020

(54) DOWNLINK DATA TRANSMISSION METHOD AND DEVICE, USER EQUIPMENT, AND BASE STATION

(71) Applicant: BEIJING XIAOMI MOBILE SOFTWARE CO., LTD., Beijing (JP)

(72) Inventor: Wei HONG, Beijing (CN)

(73) Assignee: BEIJING XIAOMI MOBILE SOFTWARE CO., LTD., Beijing (JP)

(21) Appl. No.: 16/810,151

(22) Filed: Mar. 5, 2020

Related U.S. Application Data
(63) Continuation of application No. PCT/CN2017/100779, filed on Sep. 6, 2017.

(51) Int. Cl. H04W 76/19; H04W 68/00; H04W 76/27; H04W 74/08

(52) U.S. Cl. CPC H04W 76/19; H04W 74/0833; H04W 76/27; H04W 68/005

(57) ABSTRACT

A downlink data transmission method, applied to user equipment (UE) in an inactive state, includes: receiving paging signaling from a base station; initiating a random access according to the paging signaling, and sending a third message MSG3 to the base station, the MSG3 including a Radio Resource Control (RRC) connection recovery request; and receiving a fourth message MSG4 from the base station, the MSG4 including RRC connection recovery and downlink data to be sent. As such, downlink data can be directly transmitted to a UE in an inactive state in a 5G network, and downlink data transmission can be completed through an MSG3 and an MSG4, thus improving data transmission efficiency.

### CROSS-REFERENCE TO RELATED APPLICATION

This application is a continuation of International Application No. PCT/CN2017/100779 filed on Sep. 6, 2017, the disclosure of which is hereby incorporated by reference in its entirety.

### BACKGROUND

In the past 30 years, mobile communications have experienced rapid development from voice services to mobile bandwidth data services, which not only profoundly changed people's lifestyles, but also greatly promoted social and economic development. As two main driving forces for the development of mobile communications in the future, the mobile Internet and the Internet of Things provide broad application scenarios for a 5th Generation (5G) mobile communication technology. For 2020 and beyond, the data traffic may have a thousand times of growth, and the connection of hundreds of billions of devices and diverse business requirements may bring severe challenges to the design of 5G systems. 5G may meet people's needs for ultra-high traffic density, ultra-high connection density and ultra-high mobility, and may provide users with ultimate business experiences such as high-definition video, virtual reality, augmented reality, cloud desktop, and online gaming. 5G may penetrate into the Internet of Things and other fields, and may be deeply integrated with industrial facilities, medical equipment, and transportation to fully realize the “Internet of Everything” and effectively meet the information service needs of vertical industries such as industry, medical care and transportation. 5G may also significantly improve the energy consumption and cost efficiency of network construction operations, comprehensively enhance service innovation capabilities, and expand the mobile communication industry space.

### SUMMARY

The disclosure relates generally to the technical field of communications, and more specifically to a downlink data transmission method and device, User Equipment (UE), a base station, and a computer-readable storage medium.

According to a first aspect of embodiments of the disclosure, a downlink data transmission method is provided. The method may be applied to a UE in an inactive state. The method may include:

receiving paging signaling from a base station;

initiating a random access according to the paging signaling, and sending a third message MSG3 to the base station, the MSG3 including a Radio Resource Control (RRC) connection recovery request; and

receiving a fourth message MSG4 from the base station, the MSG4 including RRC connection recovery and downlink data to be sent.

According to a second aspect of the embodiments of the disclosure, a downlink data transmission method is provided. The method may be applied to a base station. The method may include:

sending, when downlink data is determined to be transmitted by direct transmission to a UE in an inactive state, paging signaling to the UE;

receiving a third message MSG3 from the UE, the MSG3 including an RRC connection recovery request; and

returning a fourth message MSG4 to the UE, the MSG4 including RRC connection recovery and downlink data to be sent.

According to a third aspect of the embodiments of the disclosure, a UE is provided. The UE may include:

a processor; and

a memory configured to store an instruction executable by the processor.

The processor may be configured to:

receive paging signaling from a base station;

initiate a random access according to the paging signaling, and send a third message MSG3 to the base station, the MSG3 including an RRC connection recovery request; and

receive a fourth message MSG4 from the base station, the MSG4 including RRC connection recovery and downlink data to be sent.

According to a fourth aspect of the embodiments of the disclosure, a base station is provided. The base station may include:

a processor; and

a memory configured to store an instruction executable by the processor.

The processor may be configured to:

send, when downlink data is determined to be transmitted by direct transmission to a UE in an inactive state, paging signaling to the UE;

receive a third message MSG3 from the UE, the MSG3 including an RRC connection recovery request; and

return a fourth message MSG4 to the UE, the MSG4 including RRC connection recovery and downlink data to be sent.

According to a fifth aspect of the embodiments of the disclosure, a non-transitory computer-readable storage medium is provided. A computer program may be stored thereon. The program may be executed by a processor to implement the steps of the foregoing downlink data transmission method.

According to a sixth aspect of the embodiments of the disclosure, a non-transitory computer-readable storage medium is provided. A computer program may be stored thereon. The program may be executed by a processor to implement the steps of the foregoing downlink data transmission method.

The technical solutions provided by the embodiments of the disclosure may include the following beneficial effects.

A random access may be initiated according to received paging signaling, an MSG3 including an RRC connection recovery request may be sent to a base station, and then an MSG4 that is returned by the base station and includes downlink data may be received, so that the downlink data may be directly transmitted to a UE in an inactive state in a 5G network, and downlink data transmission may be completed by the MSG3 and the MSG4, thus improving data transmission efficiency.

The paging signaling may be sent to the UE, the MSG3 that is sent by the UE and includes the RRC connection recovery request may be received, and then the MSG4 including the downlink data may be returned to the UE, so that the downlink data may be directly transmitted to the UE in an inactive state in a 5G network, and downlink data transmission may be completed by the MSG3 and the MSG4, thus improving data transmission efficiency.

It is to be understood that the above general descriptions and detailed descriptions below are only exemplary and explanatory and not intended to limit the disclosure.

### BRIEF DESCRIPTION OF THE DRAWINGS

The accompanying drawings, which are incorporated in and constitute a part of this disclosure, illustrate embodiments consistent with the disclosure and, together with the specification, serve to explain the principles of the disclosure.

FIG. 1 is a flowchart showing a downlink data transmission method according to some embodiments.

FIG. 2A is a flowchart showing another downlink data transmission method according to some embodiments.

FIG. 2B is a flowchart showing another downlink data transmission method according to some embodiments.

FIG. 3 is a flowchart showing still another downlink data transmission method according to some embodiments.

FIG. 4 is a flowchart showing still another downlink data transmission method according to some embodiments.

FIG. 5 is a signaling flowchart showing a downlink data transmission method according to some embodiments.

FIG. 6 is a block diagram illustrating a downlink data transmission device according to some embodiments.

FIG. 7 is a block diagram illustrating another downlink data transmission device according to some embodiments.

FIG. 8 is a block diagram illustrating another downlink data transmission device according to some embodiments.

FIG. 9 is a block diagram illustrating a downlink data transmission device according to some embodiments.

FIG. 10 is a block diagram illustrating another downlink data transmission device according to some embodiments.

FIG. 11 is a block diagram illustrating another downlink data transmission device according to some embodiments.

FIG. 12 is a block diagram illustrating a device suitable for downlink data transmission according to some embodiments.

FIG. 13 is a block diagram illustrating another device suitable for downlink data transmission according to some embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

Because a Long-Term Evolution (LTE) network does not support a Radio Resource Control inactivate (RRC inactive) state, the LTE network does not support sending downlink data to an inactivate UE either.

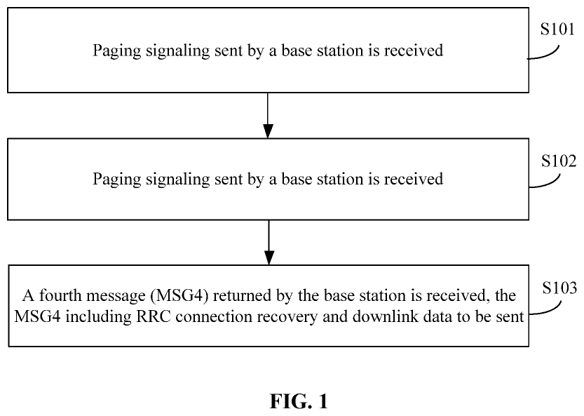

FIG. 1 is a flowchart showing a downlink data transmission method according to some embodiments. This embodiment is described from the angle of a UE in an inactive state. As shown in FIG. 1, the downlink data transmission method includes the following steps.

In step S101, paging signaling sent by a base station is received.

When a base station (gNB) has downlink data to be transmitted to a UE in an inactive state and the gNB decides to adopt direct transmission, the gNB may send paging signaling in a wireless notification region to page the UE.

In step S102, a random access is initiated according to the paging signaling, and a third message (MSG3) is sent to the base station, the MSG3 including an RRC connection recovery request.

After receiving the paging signaling, the UE needs to initiate a random access to the gNB and send an RRC connection recovery request through the MSG3.

In step S103, a fourth message (MSG4) returned by the base station is received, the MSG4 including RRC connection recovery and downlink data to be sent.

After receiving the MSG3 from the UE, the gNB may transmit downlink data to be sent through an MSG4. In addition, the MSG4 may also include indication information indicating whether there is downlink data to be sent to the UE.

In the foregoing embodiment, a random access may be initiated according to received paging signaling, an MSG3 including an RRC connection recovery request may be sent to a base station, and then an MSG4 that is returned by the base station and includes downlink data may be received, so that the downlink data can be directly transmitted to a UE in an inactive state in a 5G network, and downlink data transmission can be completed through the MSG3 and the MSG4, thus improving data transmission efficiency.

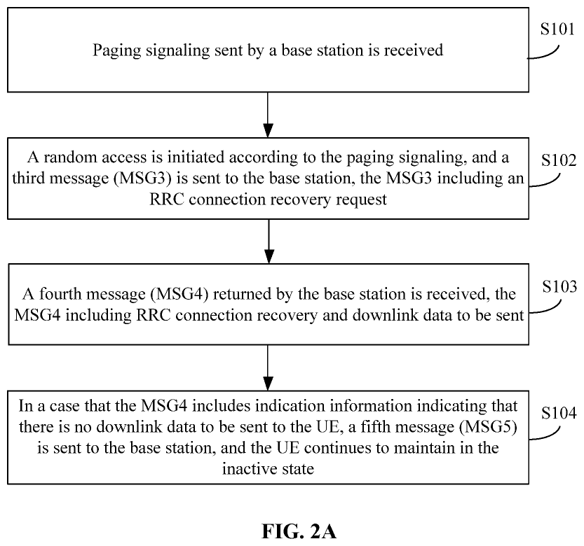

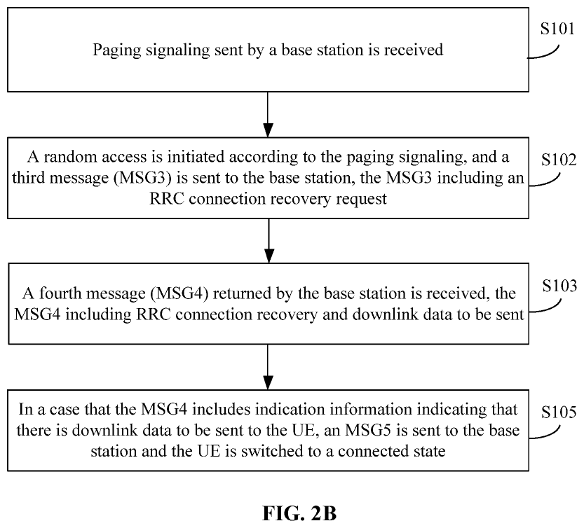

FIG. 2A is a flowchart showing another downlink data transmission method according to some embodiments. As shown in FIG. 2A, when step S103 is performed, the downlink data transmission method may further include the following steps.

In step S104, in a case that the MSG4 includes indication information indicating that there is no downlink data to be sent to the UE, a fifth message (MSG5) is sent to the base station, and the UE continues to maintain in the inactive state, the MSG5 carrying indication information indicating successful reception of the downlink data.

When the UE successfully receives the MSG4 including downlink data and the MSG4 includes indication information indicating that there is no downlink data to be sent to the UE, the UE may send an MSG5 to the gNB to indicate that the downlink data in the MSG4 has been successfully received, and continue to maintain the UE in an inactive state.

In the foregoing embodiments, in a case that the MSG4 includes indication information indicating that there is no downlink data to be sent to the UE, a fifth message MSG5 may be sent to the base station to indicate that the downlink data in the MSG4 has been successfully received and the UE may continue to maintain in an inactive state. The receiving situation of the downlink data may be fed back to the base station, and the energy consumption of the UE is reduced.

FIG. 2B is a flowchart showing another downlink data transmission method according to some embodiments. As shown in FIG. 2B, when step S103 is performed, the downlink data transmission method may further include the following steps.

In step S105, in a case that the MSG4 includes indication information indicating that there is downlink data to be sent to the UE, a fifth message MSG5 may be sent to the base station, and the UE may be switched to a connected state, the MSG5 carrying indication information indicating successful reception of the downlink data.

When the UE successfully receives the MSG4 including downlink data and the MSG4 includes indication information indicating that there is downlink data to be sent to the UE, the UE may send an MSG5 to the gNB to indicate that the downlink data in the MSG4 has been successfully received, and may be switched to a connected state, in order to receive subsequent downlink data.

In the foregoing embodiment, in a case that the MSG4 includes indication information indicating that there is downlink data to be sent to the UE, a fifth message MSG5 may be sent to the base station to indicate that the downlink data in the MSG4 has been successfully received, and the UE may be switched to a connected state, in order to receive subsequent downlink data.

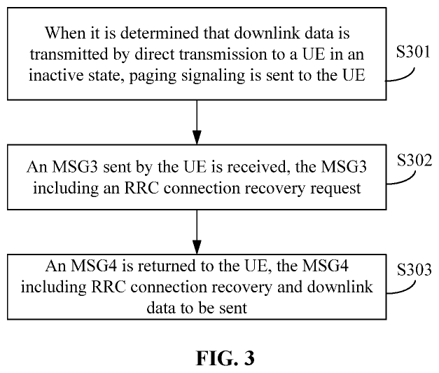

FIG. 3 is a flowchart showing still another downlink data transmission method according to some embodiments. The embodiment is described from a base station. As shown in FIG. 3, the downlink data transmission method includes the following steps.

In step S301, when it is determined that downlink data is transmitted by direct transmission to a UE in an inactive state, paging signaling is sent to the UE.

When a gNB has downlink data to be transmitted to a UE in an inactive state and the gNB decides to adopt direct transmission, the gNB may send paging signaling in a wireless notification region to page the UE.

In step S302, an MSG3 sent by the UE is received, the MSG3 including an RRC connection recovery request.

After receiving the paging signaling, the UE needs to initiate a random access to the gNB and send an RRC connection recovery request in the MSG3.

In step S303, an MSG4 is returned to the UE, the MSG4 including RRC connection recovery and downlink data to be sent.

After receiving the MSG3 from the UE, the gNB may transmit downlink data to be sent through an MSG4. In addition, the MSG4 may also include indication information indicating whether there is downlink data to be sent to the UE.

In the foregoing embodiment, the paging signaling may be sent to the UE, the MSG3 that is sent by the UE and includes the RRC connection recovery request may be received, and then the MSG4 including the downlink data may be returned to the UE, so that the downlink data can be directly transmitted to the UE in an inactive state in a 5G network, and downlink data transmission can be completed through the MSG3 and the MSG4, thus improving data transmission efficiency.

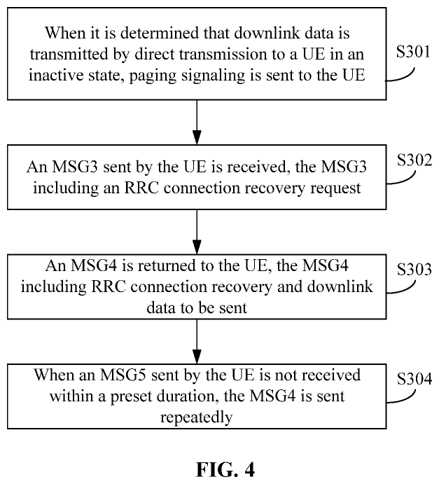

FIG. 4 is a flowchart showing still another downlink data transmission method according to some embodiments. As shown in FIG. 4, when step S303 is performed, the downlink data transmission method may further include the following steps.

In step S304, when an MSG5 sent by the UE is not received within a preset duration, the MSG4 is repeatedly sent, the MSG5 carrying indication information indicating successful reception of the downlink data.

The preset duration may be set as required.

In this embodiment, in a case that the UE does not successfully receive the MSG4 including downlink data, the MSG5 may not be sent to the gNB. In a case that the gNB does not receive the MSG5 sent by the UE within a preset duration, it may be determined that the UE does not successfully receive the MSG4, and the MSG4 may be repeatedly sent.

In the foregoing embodiment, when the MSG5 fails to be received from the UE within a preset duration, the MSG4 may be repeatedly sent so as to improve the success rate of downlink data transmission.

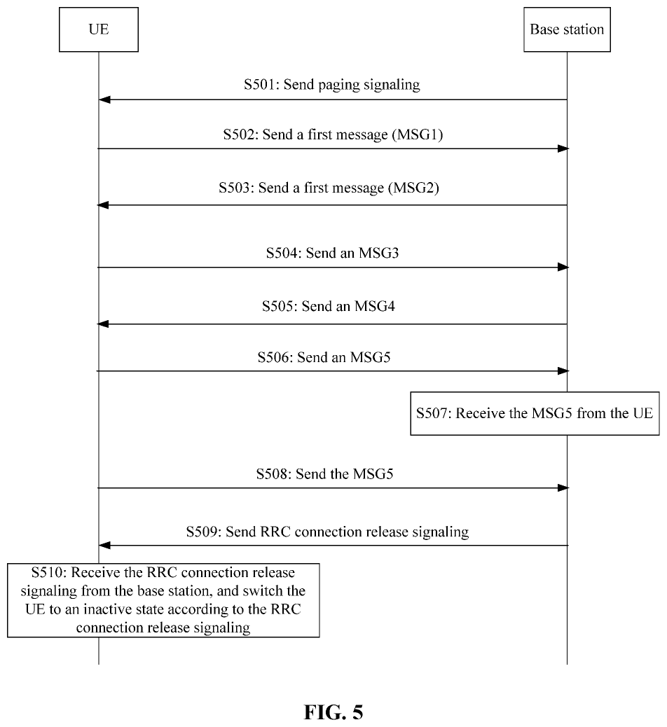

FIG. 5 is a signaling flowchart showing a downlink data transmission method according to some embodiments. This embodiment is described from the perspective of the interaction between a UE and a base station. As shown in FIG. 5, the method may include the following steps.

In step S501, a base station sends paging signaling to a UE.

In step S502, the UE sends a first message (MSG1) to the base station according to the received paging signaling.

In step S503, the base station sends a second message (MSG2) to the UE according to the received MSG1.

In step S504, the UE sends a third message MSG3 to the base station, the MSG3 including an RRC connection recovery request.

In step S505, the base station sends an MSG4 to the UE according to the received MSG3, the MSG4 including RRC connection recovery, downlink data to be sent, and indication information indicating whether there is downlink data to be sent to the UE.

In step S506, in a case that the MSG4 includes indication information indicating that there is no downlink data to be sent to the UE, the UE sends an MSG5 to the base station, and continues to maintain the UE in an inactive state.

The MSG5 may carry indication information indicating successful reception of the downlink data.

In step S507, the base station receives the MSG5 from the UE.

In step S508, in a case that the MSG4 includes indication information indicating that there is downlink data to be sent to the UE, the UE sends an MSG5 to the base station, and is switched to a connected state.

The MSG5 may carry indication information indicating successful reception of the downlink data.

In step S509, after receiving the MSG5 from the UE, upon when the downlink data is completely sent, the base station sends RRC connection release signaling to the UE.

After receiving the downlink data completely, the base station may switch the UE to an inactive state by sending the RRC connection release signaling.

In step S510, the UE receives the RRC connection release signaling from the base station, and the UE is switched to an inactive state according to the RRC connection release signaling.

In the foregoing embodiment, by sending RRC connection release signaling to the UE, the UE may be switched to an inactive state according to the RRC connection release signaling, thereby reducing energy consumption.

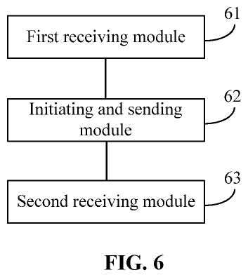

FIG. 6 is a block diagram illustrating a downlink data transmission device according to some embodiments. The device may be applied to a UE in an inactive state. As shown in FIG. 6, the device includes a first receiving module 61, an initiating and sending module 62, and a second receiving module 63.

The first receiving module 61 is configured to receive paging signaling from a base station.

When a base station (gNB) has downlink data to be transmitted to a UE in an inactive state and the gNB decides to adopt direct transmission, the gNB may send paging signaling in a wireless notification region to page the UE.

The initiating and sending module 62 is configured to initiate a random access according to the paging signaling received by the first receiving module 61, and send a third message MSG3 to the base station, the MSG3 including an RRC connection recovery request.

After receiving the paging signaling, the UE needs to initiate a random access to the gNB and send an RRC connection recovery request through the MSG3.

The second receiving module 63 is configured to receive a fourth message MSG4 returned, according to the MSG3 sent by the initiating and sending module 62, by the base station, the MSG4 including RRC connection recovery and downlink data to be sent.

After receiving the MSG3 from the UE, the gNB may transmit downlink data to be sent through an MSG4. In addition, the MSG4 may also include indication information indicating whether there is downlink data to be sent to the UE.

In the foregoing embodiment, a random access may be initiated according to a received paging signaling, an MSG3 including an RRC connection recovery request may be sent to a base station, and then an MSG4 that is returned by the base station and includes downlink data may be received, so that the downlink data can be directly transmitted to a UE in an inactive state in a 5G network, and downlink data transmission can be completed through the MSG3 and the MSG4, thus improving data transmission efficiency.

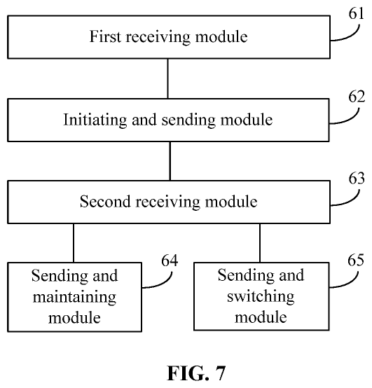

FIG. 7 is a block diagram illustrating another downlink data transmission device according to some embodiments. As shown in FIG. 7, on the basis of the foregoing embodiment shown in FIG. 6, the device may further include a sending and maintaining module 64 or a sending and switching module 65.

The sending and maintaining module 64 is configured to send, when the second receiving module 63 receives a fourth message MSG4 returned by the base station, a fifth message MSG5 to the base station in a case that the MSG4 includes indication information indicating that there is no downlink data to be sent to the UE, and continue to maintain the UE in the inactive state, the MSG5 carrying indication information indicating successful reception of the downlink data.

When the UE successfully receives the MSG4 including downlink data and the MSG4 includes indication information indicating that there is no downlink data to be sent to the UE, the UE may send an MSG5 to the gNB to indicate that the downlink data in the MSG4 has been successfully received, and continue to maintain in an inactive state.

The sending and switching module 65 is configured to send, when the second receiving module 63 receives a fourth message MSG4 returned by the base station, a fifth message MSG5 to the base station in a case that the MSG4 includes indication information indicating that there is downlink data to be sent to the UE, and switch the UE to a connected state, the MSG5 carrying indication information indicating successful reception of the downlink data.

When the UE successfully receives the MSG4 including downlink data and the MSG4 includes indication information indicating that there is downlink data to be sent to the UE, the UE may send an MSG5 to the gNB to indicate that the downlink data in the MSG4 has been successfully received, and may be switched to a connected state, in order to receive subsequent downlink data.

In the foregoing embodiment, when the MSG4 includes indication information indicating that there is no downlink data to be sent to the UE, a fifth message MSG5 may be sent to the base station to indicate that the downlink data in the MSG4 has been successfully received and the UE may continue to maintain in an inactive state. The receiving situation of the downlink data may be fed back to the base station, and the energy consumption of the UE may be reduced. When the MSG4 includes indication information indicating that there is downlink data to be sent to the UE, a fifth message MSG5 may be sent to the base station to indicate that the downlink data in the MSG4 has been successfully received, and the UE may be switched to a connected state, in order to receive subsequent downlink data.

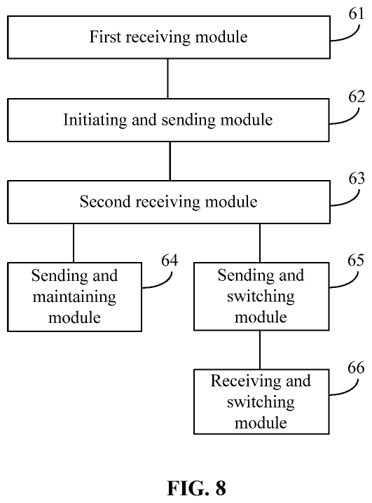

FIG. 8 is a block diagram illustrating another downlink data transmission device according to some embodiments. As shown in FIG. 8, on the basis of the foregoing embodiment shown in FIG. 7, the device may further include a receiving and switching module 66.

The receiving and switching module 66 is configured to receive, after the sending and switching module 65 switches the UE to the connected state, RRC connection release signaling from the base station upon when the downlink data is received completely, and switch the UE to the inactive state according to the RRC connection release signaling.

After receiving the downlink data completely, the base station may switch the UE to an inactive state by sending the RRC connection release signaling.

In the foregoing embodiment, an RRC connection release signaling sent by the base station may be received, and the UE may be switched to an inactive state according to the RRC connection release signaling, thereby reducing energy consumption.

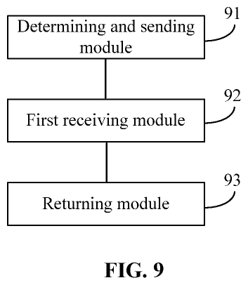

FIG. 9 is a block diagram illustrating a downlink data transmission device according to some embodiments. The device may be applied to a base station. As shown in FIG. 9, the device includes a determining and sending module 91, a first receiving module 92 and a returning module 93.

The determining and sending module 91 is configured to send, when it is determined that downlink data is transmitted to a UE in an inactive state by direct transmission, paging signaling to the UE.

When a gNB has downlink data to be transmitted to a UE in an inactive state and the gNB decides to adopt direct transmission, the gNB may send paging signaling in a wireless notification region to page the UE.

The first receiving module 92 is configured to receive, after the determining and sending module 91 sends the paging signaling to the UE, a third message MSG3 from the UE, the MSG3 including an RRC connection recovery request.

After receiving the paging signaling, the UE needs to initiate a random access to the gNB and send an RRC connection recovery request in the MSG3.

The returning module 93 is configured to return, after the first receiving module 92 receives the MSG3, a fourth message MSG4 to the UE, the MSG4 including RRC connection recovery and downlink data to be sent.

After receiving the MSG3 from the UE, the gNB may transmit downlink data to be sent through an MSG4. In addition, the MSG4 may also include indication information indicating whether there is downlink data to be sent to the UE.

In the foregoing embodiment, the paging signaling may be sent to the UE, the MSG3 that is sent by the UE and includes the RRC connection recovery request may be received, and then the MSG4 including the downlink data may be returned to the UE, so that the downlink data may be directly transmitted to the UE in an inactive state in a 5G network, and downlink data transmission may be completed through the MSG3 and the MSG4, thus improving data transmission efficiency.

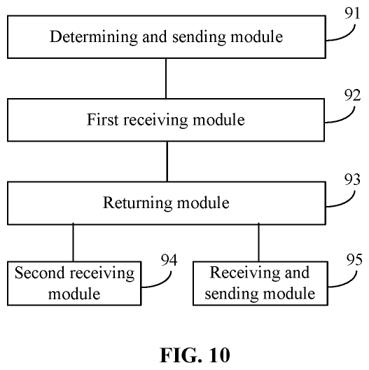

FIG. 10 is a block diagram illustrating another downlink data transmission device according to some embodiments. As shown in FIG. 10, on the basis of the foregoing embodiment shown in FIG. 9, the device may further include a second receiving module 94 or a receiving and sending module 95.

The second receiving module 94 is configured to receive, in a case that the MSG4 returned by the returning module 93 includes indication information indicating that there is no downlink data to be sent to the UE, a fifth message MSG5 from the UE, the MSG5 carrying indication information indicating successful reception of the downlink data.

When the UE successfully receives the MSG4 including downlink data and the MSG4 includes indication information indicating that there is no downlink data to be sent to the UE, the UE may send an MSG5 to the gNB to indicate that the downlink data in the MSG4 has been successfully received.

The receiving and sending module 95 is configured to send, in a case that the MSG4 returned by the returning module 93 includes indication information indicating that there is downlink data to be sent to the UE, RRC connection release signaling to the UE upon when the downlink data is sent completely after receiving a fifth message MSG5 from the UE, the MSG5 carrying indication information indicating successful reception of the downlink data.

After receiving the downlink data completely, the base station may switch the UE to an inactive state by sending the RRC connection release signaling.

In the foregoing embodiment, by receiving an MSG5 from the UE, it is possible to know the receiving situation of downlink data. RRC connection release signaling sent by the base station may be received, and the UE may be switched to an inactive state according to the RRC connection release signaling, so that the energy consumption of the UE can be reduced.

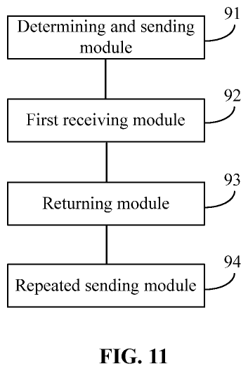

FIG. 11 is a block diagram illustrating another downlink data transmission device according to some embodiments. As shown in FIG. 11, on the basis of the foregoing embodiment shown in FIG. 9, the device may further include a repeated sending module 96.

The repeated sending module 96 is configured to repeatedly send, after the returning module 93 returns a fourth message MSG4 to the UE, the MSG4 if a fifth message MSG5 sent by the UE is not received within a preset duration, the MSG5 carrying indication information indicating successful reception of the downlink data.

The preset duration may be set as required.

In this embodiment, if the UE does not successfully receive the MSG4 including downlink data, the MSG5 may not be sent to the gNB. In a case that the gNB does not receive the MSG5 sent by the UE within a preset duration, it may be determined that the UE does not successfully receive the MSG4, and the MSG4 may be repeatedly sent.

In the foregoing embodiment, if the MSG5 sent by the UE is failed to be received within a preset duration, the MSG4 may be repeatedly sent so as to improve the success rate of downlink data transmission.

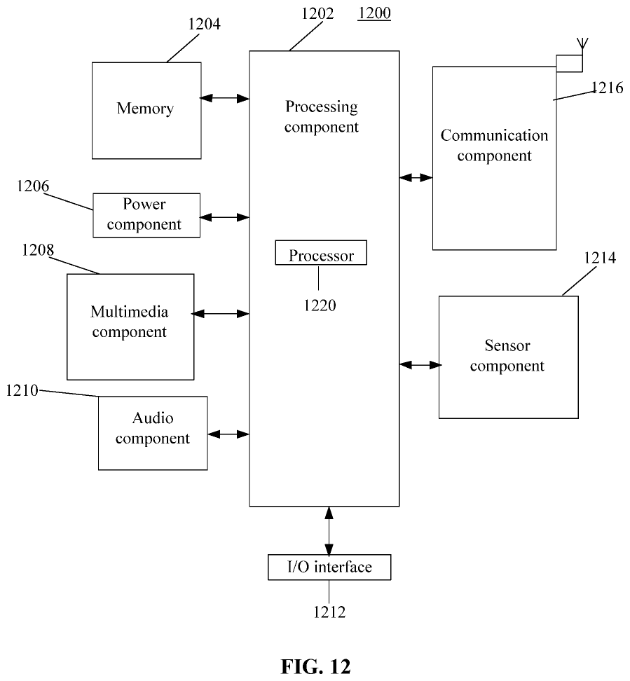

FIG. 12 is a block diagram illustrating a device suitable for downlink data transmission according to some embodiments. For example, the device 1200 may be a UE such as a mobile phone, a computer, a digital broadcast terminal, a messaging device, a gaming console, a tablet, a medical device, exercise equipment, and a personal digital assistant.

Referring to FIG. 12, the device 1200 may include one or more of the following components: a processing component 1202, a memory 1204, a power component 1206, a multimedia component 1208, an audio component 1210, an Input/Output (I/O) interface 1212, a sensor component 1214, and a communication component 1216.

The processing component 1202 is typically configured to control overall operations of the device 1200, such as operations associated with display, telephone calls, data communications, camera operations, and recording operations. The processing component 1202 may include one or more processors 1220 to execute instructions to perform all or part of the steps in the above described methods. Moreover, the processing component 1202 may include one or more modules which facilitate the interaction between the processing component 1202 and other components. For example, the processing component 1202 may include a multimedia module to facilitate the interaction between the multimedia component 1208 and the processing component 1202.

One of the processors 1220 in the processing component 1202 may be configured to:

receive paging signaling from a base station;

initiate a random access according to the paging signaling, and send a third message MSG3 to the base station, the MSG3 including an RRC connection recovery request; and

receive a fourth message MSG4 from the base station, the MSG4 including RRC connection recovery and downlink data to be sent.

The memory 1204 is configured to store various types of data to support the operation of the device 1200. Examples of such data include instructions for any applications or methods operated on the device 1200, contact data, phonebook data, messages, pictures, video, etc. The memory 1204 may be implemented using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 1206 may provide power to various components of the device 1200. The power component 1206 may include a power management system, one or more power sources, and any other components associated with the generation, management and distribution of power in the device 1200.

The multimedia component 1208 may include a screen providing an output interface between the device 1200 and the user. In some embodiments, the screen may include a Liquid Crystal Display (LCD) and a Touch Panel (TP). In some embodiments, the screen may include an organic light-emitting diode (OLED) display or other types of displays.

If the screen includes the TP, the screen may be implemented as a touch screen to receive input signals from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 1208 includes a front camera and/or a rear camera. The front camera and/or the rear camera may receive an external multimedia datum while the device 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a Microphone (MIC) configured to receive an external audio signal when the device 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, or buttons. The buttons may include, but are not limited to, a home button, a volume button, a starting button, and a locking button.

The sensor component 1214 may include one or more sensors to provide status assessments of various aspects of the device 1200. For example, the sensor component 1214 may detect an open/closed status of the device 1200, and relative positioning of components. For example, the component is the display and the keypad of the device 1200. The sensor component 1214 may also detect a change in position of the device 1200 or a component of the device 1200, a presence or absence of user contact with the device 1200, an orientation or an acceleration/deceleration of the device 1200, and a change in temperature of the device 1200. The sensor component 1214 may include a proximity sensor configured to detect the presence of nearby objects without any physical contact. The sensor component 1214 may also include a light sensor, such as a Complementary Metal Oxide Semiconductor (CMOS) or Charge Coupled Device (CCD) image sensor, for use in imaging applications. In some embodiments, the sensor component 1214 may also include an acceleration sensor, a gyroscope sensor, a magnetic sensor, a pressure sensor, or a temperature sensor.

The communication component 1216 is configured to facilitate communication, wired or wirelessly, between the device 1200 and other devices. The device 1200 may access a wireless network based on a communication standard, such as Wi-Fi, 2G, 3G, 4G, or 5G, or a combination thereof. In one exemplary embodiment, the communication component 1216 receives a broadcast signal or broadcast associated information from an external broadcast management system via a broadcast channel. In one exemplary embodiment, the communication component 1216 further includes a Near Field Communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In some embodiments, the device 1200 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors, or other electronic elements, for performing the above described methods.

In some embodiments, there is also provided a non-transitory computer-readable storage medium including instructions, such as included in the memory 1204, executable by the processor 1220 of the device 1200 to implement the above described methods. For example, the non-transitory computer-readable storage medium may be a ROM, a Random Access Memory (RAM), a Compact Disc Read-Only Memory (CD-ROM), a magnetic tape, a floppy disc, an optical data storage device and the like.

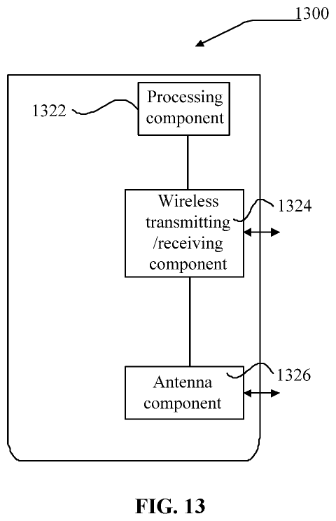

FIG. 13 is a block diagram illustrating another device suitable for downlink data transmission according to some embodiments. A device 1300 may be provided as a base station. Referring to FIG. 13, the device 1300 includes a processing component 1322, a wireless transmitting/receiving component 1324, an antenna component 1326, and a wireless interface-specific signal processing portion. The processing component 1322 may further include one or more processors.

One processor in the processing component 1322 may be configured to:

send, when it is determined that downlink data is transmitted to a UE in an inactive state by direct transmission, paging signaling to the UE;

receive a third message MSG3 from the UE, the MSG3 including an RRC connection recovery request; and

return a fourth message MSG4 to the UE, the MSG4 including RRC connection recovery and downlink data to be sent.

In exemplary embodiments, there is also provided a non-transitory computer-readable storage medium including instructions, executable by the processor 1322 of the device 1300 to implement the above described methods. For example, the non-transitory computer-readable storage medium may be a ROM, a Random Access Memory (RAM), a Compact Disc Read-Only Memory (CD-ROM), a magnetic tape, a floppy disc, an optical data storage device and the like.

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

The above description includes part of embodiments of the present disclosure, and not limits the present disclosure. Any modifications, equivalent substitutions, improvements, etc., within the spirit and principles of the present disclosure, are included in the scope of protection of the present disclosure.

It is apparent that those of ordinary skill in the art can make various modifications and variations to the embodiments of the disclosure without departing from the spirit and scope of the disclosure. Thus, it is intended that the present disclosure cover the modifications and the modifications.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion within a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, or the device including the element.

Specific examples are used herein to describe the principles and implementations of some embodiments. The description is only used to help convey understanding of the possible methods and concepts. Meanwhile, those of ordinary skill in the art can change the specific manners of implementation and application thereof without departing from the spirit of the disclosure. The contents of this specification therefore should not be construed as limiting the disclosure.

For example, in the description of the present disclosure, the terms “some embodiments,” or “example,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In the descriptions, with respect to circuit(s), unit(s), device(s), component(s), etc., in some occurrences singular forms are used, and in some other occurrences plural forms are used in the descriptions of various embodiments. It should be noted; however, the single or plural forms are not limiting but rather are for illustrative purposes. Unless it is expressly stated that a single unit, device, or component etc. is employed, or it is expressly stated that a plurality of units, devices or components, etc. are employed, the circuit(s), unit(s), device(s), component(s), etc. can be singular, or plural.

Based on various embodiments of the present disclosure, the disclosed apparatuses, devices, and methods can be implemented in other manners. For example, the abovementioned devices can employ various methods of use or implementation as disclosed herein.

In the present disclosure, the terms “installed,” “connected,” “coupled,” “fixed” and the like shall be understood broadly, and may be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

Dividing the device into different “regions,” “units,” “components” or “layers,” etc. merely reflect various logical functions according to some embodiments, and actual implementations can have other divisions of “regions,” “units,” “components” or “layers,” etc. realizing similar functions as described above, or without divisions. For example, multiple regions, units, or layers, etc. can be combined or can be integrated into another system. In addition, some features can be omitted, and some steps in the methods can be skipped.

Those of ordinary skill in the art will appreciate that the units, components, regions, or layers, etc. in the devices provided by various embodiments described above can be provided in the one or more devices described above. They can also be located in one or multiple devices that is (are) different from the example embodiments described above or illustrated in the accompanying drawings. For example, the units, regions, or layers, etc. in various embodiments described above can be integrated into one module or divided into several sub-modules.

The various device components, modules, units, blocks, or portions may have modular configurations, or are composed of discrete components, but nonetheless can be referred to as “modules” in general. In other words, the “components,” “modules,” “blocks,” “portions,” or “units” referred to herein may or may not be in modular forms.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

The order of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to the disclosed aspects of the exemplary embodiments can be made in addition to those described above by a person of ordinary skill in the art having the benefit of the present disclosure without departing from the spirit and scope of the disclosure contemplated by this disclosure and as defined in the following claims. As such, the scope of this disclosure is to be accorded the broadest reasonable interpretation so as to encompass such modifications and equivalent structures.

1. A downlink data transmission method, applied to User Equipment (UE) in an inactive state, the method comprising:
receiving paging signaling from a base station;
initiating a random access according to the paging signaling, and sending a third message (MSG3) to the base station, the MSG3 comprising a Radio Resource Control (RRC) connection recovery request; and
receiving a fourth message (MSG4) from the base station, the MSG4 comprising RRC connection recovery and downlink data to be sent.

2. The method according to claim 1, wherein the MSG4 further comprises indication information indicating whether there is downlink data to be sent to the UE.

3. The method according to claim 2, further comprising:
when receiving the MSG4 from the base station, sending a fifth message (MSG5) to the base station in a case that the MSG4 comprises indication information indicating that there is no downlink data to be sent to the UE, and continuing to maintain the UE in the inactive state, the MSG5 carrying indication information indicating successful reception of the downlink data; or
when receiving the MSG4 from the base station, sending a fifth message (MSG5) to the base station in a case that the MSG4 comprises indication information indicating that there is downlink data to be sent to the UE, and switching the UE to a connected state, the MSG5 carrying indication information indicating successful reception of the downlink data.

4. The method according to claim 3, further comprising:
after switching the UE to the connected state, receiving RRC connection release signaling from the base station upon when the downlink data is received completely, and switching the UE to the inactive state according to the RRC connection release signaling.

5. A downlink data transmission method, applied to a base station, the method comprising:
when downlink data is determined to be transmitted by direct transmission to User Equipment (UE) in an inactive state, sending paging signaling to the UE;
receiving a third message (MSG3) from the UE, the MSG3 comprising a Radio Resource Control (RRC) connection recovery request; and
returning a fourth message (MSG4) to the UE, the MSG4 comprising RRC connection recovery and downlink data to be sent.

6. The method according to claim 5, wherein the MSG4 further comprises indication information indicating whether there is downlink data to be sent to the UE.

7. The method according to claim 6, further comprising:
in a case that the MSG4 comprises indication information indicating that there is no downlink data to be sent to the UE, receiving a fifth message (MSG5) from the UE, the MSG5 carrying indication information indicating successful reception of the downlink data; or
in a case that the MSG4 comprises indication information indicating that there is downlink data to be sent to the UE, after receiving a fifth message (MSG5) from the UE, sending RRC connection release signaling to the UE upon when the downlink data is sent completely, the MSG5 carrying indication information indicating successful reception of the downlink data.

8. The method according to claim 5, further comprising:
after returning the MSG4 to the UE, repeatedly sending the MSG4 when a fifth message (MSG5) sent by the UE is not received within a preset duration, the MSG5 carrying indication information indicating successful reception of the downlink data.

9. A device, comprising:
a processor; and
memory configured to store an instruction executable by the processor,
wherein the processor is configured to:
receive paging signaling from a base station;
initiate a random access according to the paging signaling, and send a third message (MSG3) to the base station, the MSG3 comprising a Radio Resource Control (RRC) connection recovery request; and
receive a fourth message (MSG4) from the base station, the MSG4 comprising RRC connection recovery and downlink data to be sent.

10. The device according to claim 9, wherein the MSG4 further comprises indication information indicating whether there is downlink data to be sent to a UE.

11. The device according to claim 10, wherein the processor is further configured to:
send, when receiving the MSG4 from the base station, a fifth message (MSG5) to the base station in a case that the MSG4 comprises indication information indicating that there is no downlink data to be sent to a UE, and continue to maintain the UE in the inactive state, the MSG5 carrying indication information indicating successful reception of the downlink data; or
send, when receiving the MSG4 from the base station, a fifth message (MSG5) to the base station in a case that the MSG4 comprises indication information indicating that there is downlink data to be sent to a UE, and switch the UE to a connected state, the MSG5 carrying indication information indicating successful reception of the downlink data.

12. The device according to claim 11, wherein the processor is further configured to:
receive, after switching the UE to the connected state, RRC connection release signaling from the base station upon when the downlink data is received completely, and switch the UE to the inactive state according to the RRC connection release signaling.

13. A device implementing the method of claim 5, comprising:
a processor; and
memory storing instructions for execution by the processor to perform steps of the method.

14. The device according to claim 13, wherein the MSG4 further comprises indication information indicating whether there is downlink data to be sent to the UE.

15. The device according to claim 14, wherein the processor is further configured to:
receive, in a case that the MSG4 comprises indication information indicating that there is no downlink data to be sent to the UE, a fifth message (MSG5) from the UE, the MSG5 carrying indication information indicating successful reception of the downlink data; or
send, in a case that the MSG4 comprises indication information indicating that there is downlink data to be sent to the UE, RRC connection release signaling to the UE upon when the downlink data is sent completely after receiving a fifth message (MSG5) from the UE, the MSG5 carrying indication information indicating successful reception of the downlink data.

16. The device according to claim 13, wherein the processor is further configured to:
repeatedly send, after returning the MSG4 to the UE, the MSG4 when a fifth message (MSG5) sent by the UE is not received within a preset duration, the MSG5 carrying indication information indicating successful reception of the downlink data.

17. A non-transitory computer-readable storage medium, having a computer program stored thereon for execution by a processor to implement the steps of the downlink data transmission method according to claim 1.

18. The non-transitory computer-readable storage medium according to claim 17, wherein the processor is configured to execute the computer program to further implement steps of:
when receiving the MSG4 from the base station, sending a fifth message (MSG5) to the base station in a case that the MSG4 comprises indication information indicating that there is no downlink data to be sent to the UE, and continuing to maintain the UE in the inactive state, the MSG5 carrying indication information indicating successful reception of the downlink data; or
when receiving the MSG4 from the base station, sending a fifth message (MSG5) to the base station in a case that the MSG4 comprises indication information indicating that there is downlink data to be sent to the UE, and switching the UE to a connected state, the MSG5 carrying indication information indicating successful reception of the downlink data.

19. A non-transitory computer-readable storage medium, having a computer program stored thereon for execution by a processor to implement steps of the downlink data transmission method according to claim 5, wherein the processor is configured to execute the computer program to further implement steps of:
in a case that the MSG4 comprises indication information indicating that there is no downlink data to be sent to the UE, receiving a fifth message (MSG5) from the UE, the MSG5 carrying indication information indicating successful reception of the downlink data; or
in a case that the MSG4 comprises indication information indicating that there is downlink data to be sent to the UE, after receiving a fifth message (MSG5) from the UE, sending RRC connection release signaling to the UE upon when the downlink data is sent completely, the MSG5 carrying indication information indicating successful reception of the downlink data.

20. A 5G communication system implementing the method of claim 1, comprising the UE and the base station, wherein the base station is configured to:
send paging signaling to the UE;
receive the MSG3 sent by the UE including the RRC connection recovery request; and
return the MSG4 including the downlink data to the UE, such that the downlink data are directly transmitted to the UE in the inactive state in a 5G network, facilitated by the MSG3 and the MSG4, thereby improving data transmission efficiency.
